(19) United States
(12) Patent Application Publication
(10) Pub. No.: US 2023/0211706 A1
(43) Pub. Date: Jul. 6, 2023

(54) A FUEL CELL AND BATTERY HYBRID SYSTEM

(71) Applicant: FUEL CELL TECHNOLOGY SWEDEN AB, Sollentuna, SE (US)

(72) Inventor: Sebastian WEBER, Malmö (SE)

(21) Appl. No.: 17/928,570

(22) PCT Filed: May 6, 2021
(86) PCT No.: PCT/SE2021/050423

§ 371 Date: Nov. 29, 2022

(30) Foreign Application Priority Data
Jun. 5, 2020 (SE) 2050663-0

(51) Int. Cl. B60L 58/40; B60L 50/75; B60L 58/12; B60L 53/20; H01M 16/00; H01M 8/04089

(52) U.S. Cl. CPC B60L 58/40; B60L 50/75; B60L 53/20; B60L 58/12; H01M 8/04089; H01M 16/006; B60L 2210/10; H01M 2008/1095

(57) ABSTRACT

Described herein is a fuel cell and battery hybrid system (1) comprising one or more sets (2) of serially connected fuel cells (FC1-n). The one or more sets (2) of serially connected fuel cells (FC1-n) are further serially connected via a respective fuel cell series enhancer (3). The serially connected sets (2) are further connected in parallel with a battery (4) via a fuel cell power charge controller (5). Each respective set (2) of serially connected fuel cells (FC1-n) is further arranged be controlled by the fuel cell series enhancer (3) to operate electrically independent from other sets (2) of serially connected fuel cells (FC1-n) and at its own unique maximum power point or uniquely selected other operating point, regardless of the operating points of other sets (2) of serially connected fuel cells (FC1-n).

### TECHNICAL FIELD

The present disclosure relates generally to a fuel cell and battery hybrid system.

### BACKGROUND

Fuels cells have attracted an increased interest as suitable for use in a number of applications recently, such as applications for zero emission automotive solutions intended to shift the result of road vehicle energy usage from CO₂ emissions, to harmless H₂O emissions, i.e. water exhausts.

Although fuel cells s are good energy sources to provide reliable power at steady state they cannot, however, respond to electrical load transients quickly. This is due to their slow internal electrochemical and thermodynamic characteristics. Furthermore, as fuel cells only can deliver maximum power under specific electrical conditions, that vary based on available hydrogen and oxygen, its humidity, the temperature, etc., the incorporation of this technology in vehicle propulsion systems has been slow.

However, an advantage of using fuel cells for generating electric motive power for road vehicles is that such road vehicles may use on-board hydrogen storage units, that quickly and easily may be resupplied from a hydrogen refilling station, as compared to the usually rather prolonged charging times of current pure battery electric vehicles.

### SUMMARY

An object of the present invention is to provide an improved fuel cell and battery hybrid system.

According to a first aspect this is provided through a fuel cell and battery hybrid system comprising one or more sets of serially connected fuel cells, the one or more sets of serially connected fuel cells further being serially connected via a respective fuel cell series enhancer and the serially connected sets further being connected in parallel with a battery via a fuel cell power charge controller, wherein each respective set of serially connected fuel cells further is arranged be controlled by the fuel cell series enhancer to operate electrically independent from other sets of serially connected fuel cells and at its own unique maximum power point or uniquely selected other operating point, regardless of the operating points of other sets of serially connected fuel cells.

The above fuel cell and battery hybrid system allows for quick responses to electrical load transients.

In one embodiment the fuel cell power charge controller is arranged to regulate the operating point of the serially connected sets of serially connected fuel cells to its maximum power point and, for a constant current charge phase of the battery, follow the battery voltage and supply maximum current to the battery based on the battery state of charge or load.

In other embodiments each respective set of serially connected fuel cells further comprises a power controller arranged to regulate hydrogen and airflow to the fuel cells thereof in relation to optimal power generation and thermal conditions.

In further embodiments each respective fuel cell series enhancer comprises at least one DC-DC converter arranged control the output power of the respective set of serially connected fuel cells using a pulse width modulation loop.

In some of those further embodiments the pulse width modulation loop is arranged to vary the operating point voltage with a predetermined step width to search for the maximum power point or uniquely selected other operating point, and control the output power of the respective set of serially connected fuel cells to maintain the maximum power point or uniquely selected other operating point.

In additional embodiments each fuel cell in the respective sets of serially connected fuel cells further is equipped with a bypass functionality arranged to provide a current bypass of that respective fuel cell if it is unable to work at the operating point of the other fuel cells in that set.

In some of those additional embodiments the bypass functionality is arranged to provide for bypass of the fuel cell at a configurable threshold and cancel bypass following another configurable threshold having been reached during a certain configurable time period.

In still further embodiments the fuel cells in the sets of serially connected fuel cells are open-end Single Proton Exchange Membrane Fuel Cells.

Some of the above embodiments have the beneficial effect of enabling the fuel cell and battery hybrid system to respond to electrical load transients quickly.

Besides allowing for quick responses to electrical load transients, at least some of the above embodiments enables the series of fuel cells to deliver their collective maximum power into a wide range of load conditions.

Furthermore, at least some of the above embodiments enables elimination of mismatch in the series of fuel cells and thus elimination of potential power loss resulting therefrom.

### BRIEF DESCRIPTION OF DRAWINGS

In the following, embodiments herein will be described in greater detail by way of example only with reference to attached drawings, in which:

FIG. 1 illustrates schematically a fuel cell and battery hybrid system according to embodiments herein.

FIG. 2 illustrates schematically the fuel cell and battery hybrid system arranged with a Fuel Cell Control system and a Battery Management System.

### DESCRIPTION OF EMBODIMENTS

In the following will be described some example embodiments of an improved fuel cell and battery hybrid system 1, which fuel cell and battery hybrid system 1 is able to respond to electrical load transients quickly, and thus is suitable e.g. for generating electric motive power for road vehicles.

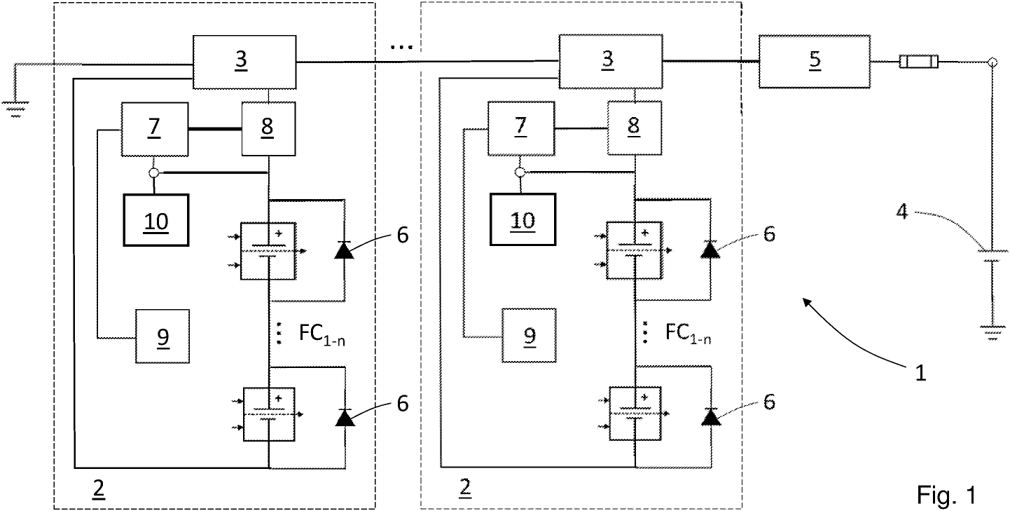

As illustrated in FIG. 1 the fuel cell and battery hybrid system 1 comprise one or more sets 2 of serially connected fuel cells FC₁₋ₙ, also referred to herein as sets of fuel cell series, shown in FIG. 1 framed with dashed lines. The fuel cells FC₁₋ₙ in the respective sets 2 are connected in series to achieve higher potentials, making the sets 2 easier to control, as will be elucidated in the following.

The one or more sets 2 of serially connected fuel cells FC₁₋ₙ are further serially connected via a respective fuel cell series enhancer 3. Series connection of fuel cells creates a sensitivity to cell operational mismatch, resulting in less than optimal power and energy production under real-world conditions. The use of a fuel cell series enhancer 3 enables a series of fuel cells FC₁₋ₙ to deliver their collective maximum power into a wide range of load conditions. This enhanced electrical flexibility eliminates power loss from mismatch in a series of fuel cells, ultimately improving energy production and system 1 design flexibility.

The fuel cell series enhancers 3 have the further advantages of reducing performance degradation over the fuel cell system operating lifetime, eliminating high power losses, as compared with using a statically selected fuel cell operating point or normal bypass diodes, and facilitates establishing an operating point for limiting the operating voltage and current of a series of fuel cells.

The serially connected sets 2 of fuel cell series FC₁₋ₙ are furthermore connected in parallel with a battery 4, such as a lithium-ion battery, via a fuel cell power charge controller 5. A maximum power point tracking (MPPT) fuel cell charge controller 5 is used to extract the maximum available power from the serially connected sets 2 of fuel cell series FC₁₋ₙ, connected via their respective fuel cell-series enhancer 3. The operating point of the sets 2 of fuel cell series FC₁₋ₙ is regulated to its maximum power point and, for the constant current charge phase of the battery 4, follows the battery 4 voltage and supplies the maximum current to the battery 4.

Each respective set 2 of serially connected fuel cells FC₁₋ₙ is further arranged be controlled by the fuel cell series enhancer 3 to operate electrically independent from other sets 2 of serially connected fuel cells FC₁₋ₙ and at its own unique maximum power point or uniquely selected other operating point, regardless of the operating points of other sets 2 of serially connected fuel cells FC₁₋ₙ.

The fuel cell system operation is requested based on the batteries state of charge or additional external source need of power.

Thus, the above fuel cell and battery hybrid system 1 allows for quick responses to electrical load transients. This is important as fuel cells by themselves are good energy sources to provide reliable power at steady state. However, due to their relatively slow internal electrochemical and thermodynamic characteristics, they cannot by themselves respond to electrical load transients quickly. As described herein, an accumulator, such as a battery 4, in hybrid configuration with fuel cells, is the perfect match to manage that.

In some embodiments the fuel cell power charge controller 5, of the fuel cell and battery hybrid system 1 described herein, is arranged to regulate the operating point of the serially connected sets 2 of serially connected fuel cells FC₁₋ₙ to its maximum power point and, for a constant current charge phase of the battery 4, follow the battery 4 voltage and supply maximum current to the battery 4 based on the battery 4 state of charge or load.

The fuel cell system architecture of the fuel cell and battery hybrid system 1 described herein suitably encompasses hydrogen and air flow regulation, thermal management, and electrical connection in a symbiotic relationship with a properly sized battery 4.

Thus, in some embodiments each respective set 2 of serially connected fuel cells further comprises a power controller 7 arranged to regulate hydrogen and airflow to the fuel cells thereof in relation to optimal power generation and thermal conditions. In order to perform such control, the power controller 7 may, as illustrated in FIG. 1, employ a volt meter 10, a current sense amplifier 8 and a temperature sensor 9, for the respective sets 2 of serially connected fuel cells. Hydrogen and airflow to the fuel cells is illustrated schematically by the arrows connecting to the left-hand sides of the respective fuel cells, whereas exhaust water is illustrated by the dotted arrow leaving the respective fuel cells from the right-hand sides thereof.

The heart of the fuel cell electrical control is to draw the proper power out of the fuel cell. This is done via a DC-DC converter. In any DC-DC converter design it is vital to, whilst reaching the control targets, still retain a high efficiency. A DC-DC converter generally has greater losses at high currents and at low voltage, exactly what a single fuel cell produces. A single fuel cell has the theoretical working range of slightly above 1 volt down to zero volts, and a current proportional to the physical membrane area and the amount of hydrogen gas supplied and is easily counted in Amps. The low voltage of a single fuel cell does not make it possible achieve high efficiency, this since it is on par with a transistor terminal voltage. For this reason, the serial connection of fuel cells FC₁₋ₙ is used to increase the voltage input to the DC-DC converter and by that the efficiency thereof.

Thus, in some further embodiments each respective fuel cell series enhancer 3 comprises at least one DC-DC converter arranged control the output power of the respective set 2 of serially connected fuel cells FC₁₋ₙ using a pulse width modulation loop.

In some of these further embodiments the pulse width modulation loop is arranged to vary the operating point voltage with a predetermined step width to search for the maximum power point or uniquely selected other operating point, and control the output power of the respective set 2 of serially connected fuel cells FC₁₋ₙ to maintain the maximum power point or uniquely selected other operating point.

In the series of fuel cells FC₁₋ₙ each fuel cell is equipped with a bypass functionality 6 that will bypass the current if the cell is not able to work at the operating point of the other fuel cells in series. This will remove the power loss impact on the other fuel cells in series and retain the longevity of the bypassed cell. The preferred bypass functionality 6 is of an active type, that have a minimal forward bias power impact and thus have a minimal power dissipation impact due to the current drawn by the other fuel cells in series.

Thus, in some additional embodiments each fuel cell FC₁₋ₙ in the respective sets 2 of serially connected fuel cells is further equipped with a bypass functionality 6 arranged to provide a current bypass of that respective fuel cell if it is unable to work at the operating point of the other fuel cells in that set 2.

In in some of these additional embodiments the bypass functionality 6 is arranged to provide for bypass of the fuel cell at a configurable threshold and cancel bypass following another configurable threshold having been reached during a certain configurable time period.

For the embodiments of the fuel cell and battery hybrid system 1 described herein it is advantageous if the fuel cells in the sets 2 of serially connected fuel cells FC₁₋ₙ are open-end Single Proton Exchange Membrane Fuel Cells.

Where some prior-art fuel cell systems can be very bulky the use of small, flat and shapeable fuel cells, i.e. micro fuel cells, such as single Proton Exchange Membrane (PEM) fuel cells with an open-end design, e.g. applicants myFC LAMINA™ fuel cells, gives an improved freedom of geometrical design and distributed placement for the fuel cell and battery hybrid system 1 described herein, providing flexibility in applications, such as applications suitable for automotive vehicles.

The myFC LAMINA™ fuel cells referenced above use hydrogen gas and transform it into clean power. It all starts with a single Proton Exchange Membrane (PEM) fuel cell with an open-end design. Since the myFC LAMINA™ fuel cell design also can use passive air feed and comprise no conventional bi-polar plates, it provides cost advantages and requires a less complicated manufacturing process, as compared to fuel cells comprising conventional bi-polar plates. Thus, using thin, formable, high power density, and low-cost mass producible myFC LAMINA™ fuel cells with an open ended hydrogen system for the fuel cell and battery hybrid system 1 described herein allows for scalable flexibility in configuring and tailoring fuel cell and battery hybrid systems 1 to a multitude of differing applications.

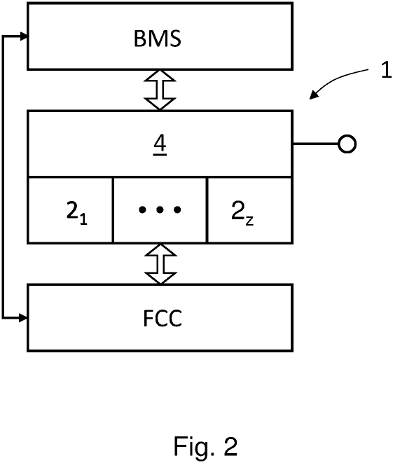

In order to control the the fuel cell and battery hybrid system 1 described herein there should preferably, as illustrated schematically in FIG. 2, be added a Fuel Cell Control system (FCC) and a Battery Management System (BMS). In the fuel cell and battery hybrid system 1 the FCC is arranged to communicate with the Battery Management System (BMS) to combine the strengths of the fuel cell and battery 4 technologies. The sets 2 of serially connected fuel cells FC₁₋ₙ in FIG. 2 denoted as sets 2₁ to 2_{z}.

Thus, by combining fuel cells with a battery 4, in a hybrid solution as described above, it is possible to leverage each technology’s advantages and balance out their disadvantages, offering the best possible electric performance.

The fuel cell and battery hybrid system 1, as described above, addresses some of the limitations of fuel cells as well as some of the limitations of batteries 4, in particular of lithium-ion batteries.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A fuel cell and battery hybrid system comprising one or more sets of serially connected fuel cells, the one or more sets of serially connected fuel cells further being serially connected via a respective fuel cell series enhancer and the serially connected sets further being connected in parallel with a battery via a fuel cell power charge controller, wherein
each respective set of serially connected fuel cells further is arranged be controlled by the fuel cell series enhancer to operate electrically independent from other sets of serially connected fuel cells and at its own unique maximum power point or uniquely selected other operating point, regardless of the operating points of other sets of serially connected fuel cells.

2. The fuel cell and battery hybrid system according to claim 1, wherein the fuel cell power charge controller is arranged to regulate the operating point of the serially connected sets of serially connected fuel cells to its maximum power point and, for a constant current charge phase of the battery, follow the battery voltage and supply maximum current to the battery based on the battery state of charge or load.

3. The fuel cell and battery hybrid system according to claim 1, wherein each respective set of serially connected fuel cells further comprises a power controller arranged to regulate hydrogen and airflow to the fuel cells-thereof in relation to optimal power generation and thermal conditions.

4. The fuel cell and battery hybrid system according to claim 1, wherein each respective fuel cell series enhancer comprises at least one DC-DC converter arranged control the output power of the respective set of serially connected fuel cells using a pulse width modulation loop.

5. The fuel cell and battery hybrid system according claim 4, wherein the pulse width modulation loop is arranged to vary the operating point voltage with a predetermined step width to search for the maximum power point or uniquely selected other operating point, and control the output power of the respective set of serially connected fuel cells to maintain the maximum power point or uniquely selected other operating point.

6. The fuel cell and battery hybrid system according to claim 1, wherein each fuel cell in the respective sets of serially connected fuel cells further is equipped with a bypass functionality arranged to provide a current bypass of that respective fuel cell if it is unable to work at the operating point of the other fuel cells in that set.

7. The fuel cell and battery hybrid system according to claim 6, wherein the bypass functionality is arranged to provide for bypass of the fuel cell at a configurable threshold and cancel bypass following another configurable threshold having been reached during a certain configurable time period.

8. The fuel cell and battery hybrid system according to claim 1, wherein the fuel cells in the sets of serially connected fuel cells are open-end Single Proton Exchange Membrane Fuel Cells.
